(19) United States
(12) Patent Application Publication
(10) Pub. No.: US 2025/0136370 A1
(43) Pub. Date: May 1, 2025

(54) DEPLOYABLE REFUSE COLLECTION VEHICLE

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Nagabhushana Sharma Gurumurthy, Oshkosh, WI (US); Johnny Bui, Oshkosh, WI (US); Monika Nagalla, Oshkosh, WI (US); John Zucca, Oshkosh, WI (US)

(73) Assignee: Oshkosh Corporation, Oshkosh, WI (US)

(21) Appl. No.: 18/917,647

(22) Filed: Oct. 16, 2024

Related U.S. Application Data
(60) Provisional application No. 63/593,778, filed on Oct. 27, 2023.

(51) Int. Cl. B65F 3/04; B65F 3/02; B66F 9/06; B66F 9/075; B66F 9/18

(52) U.S. Cl. CPC B65F 3/04; B66F 9/063; B66F 9/0755; B66F 9/07563; B66F 9/18; B65F 2003/0269; B65F 2003/0279

(57) ABSTRACT

A refuse collection system includes a deployable refuse collection vehicle and a control system. The deployable refuse collection vehicle is configured to deploy from a refuse vehicle. The deployable refuse collection vehicle includes a chassis, a drive system coupled to the chassis, one or more sensors configured to acquire data to facilitate detecting a refuse can, a grip apparatus configured to engage the refuse can. The control system is configured to detect the refuse can based on the data, control the drive system to navigate the deployable refuse collection vehicle to the refuse can, and control the grip apparatus to engage with the refuse can.

### CROSS-REFERENCE TO RELATED PATENT APPLICATION

This application claims the benefit of and priority to U.S. Provisional Patent Application No. 63/593,778, filed Oct. 27, 2023, which is incorporated herein by reference in its entirety.

### BACKGROUND

The present disclosure generally relates to the field of refuse vehicles. More specifically, the present disclosure relates to control systems for refuse vehicles.

### SUMMARY

One embodiment relates to a refuse collection system. The refuse collection system includes a deployable refuse collection vehicle and a control system. The deployable refuse collection vehicle is configured to deploy from a refuse vehicle. The deployable refuse collection vehicle includes a chassis, a drive system coupled to the chassis, one or more sensors configured to acquire data to facilitate detecting a refuse can, a grip apparatus configured to engage the refuse can. The control system is configured to detect the refuse can based on the data, control the drive system to navigate the deployable refuse collection vehicle to the refuse can, and control the grip apparatus to engage with the refuse can.

Another embodiment relates to a refuse collection system. The refuse collection system includes a refuse collection robot and a control system. The refuse collection robot includes a drive system, a sensor configured to acquire data to facilitate detecting a refuse can, and a grabber configured to engage the refuse can. The control system is configured to detect the refuse can based on the data, control the drive system to navigate the refuse collection robot to the refuse can, and control the grabber to engage with the refuse can.

Still another embodiment relates to a refuse collection system. The refuse collection system includes a front-loading refuse collection vehicle having a lift assembly and a dock, a carry can detachably coupled to the lift assembly where the carry can includes a grabber mechanism, and a deployable robot selectively coupled to the dock where the deployable robot has a battery chargeable at the dock. The deployable robot is configured to engage with the carry can when the carry can is detached from the lift assembly such that the carry can is movable by the deployable robot.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a front-loading refuse vehicle, according to an exemplary embodiment.

FIG. 2 is a side view of a rear-loading refuse vehicle, according to an exemplary embodiment.

FIG. 3 is a perspective view of a side-loading refuse vehicle, according to an exemplary embodiment.

FIG. 4 is a block diagram of a control system for the refuse vehicles of FIGS. 1-3 interoperable with a deployable refuse collection vehicle, according to an exemplary embodiment.

FIG. 5 is a diagram illustrating a collection route for autonomous transport and collection by the refuse vehicles of FIGS. 1-3, according to an exemplary embodiment.

FIG. 6 is a block diagram of a system for refuse collection including a deployable refuse collection vehicle and the refuse vehicles of FIGS. 1-3, according to an exemplary embodiment.

FIG. 7 is a block diagram illustrating the deployable refuse collection vehicle of FIG. 6 in relation to a refuse can, according to an exemplary embodiment.

FIG. 8 is a diagram of a grabber apparatus of the deployable refuse collection vehicle of FIG. 7, according to an exemplary embodiment.

FIG. 9 is a flow chart of a process for utilizing the deployable refuse collection vehicle of FIG. 6, according to an exemplary embodiment.

FIG. 10 is a diagram illustrating use of the deployable refuse collection vehicle of FIG. 6 with the refuse vehicles of FIGS. 1-3, according to an exemplary embodiment.

FIG. 11 is a graphical user interface illustrating a view from a sensor of the deployable refuse collection vehicle of FIG. 6, including a superimposed path to a refuse container, according to an exemplary embodiment.

FIG. 12 is a block diagram of a system for refuse collection including a deployable refuse collection vehicle and the refuse vehicles of FIGS. 1-3, according to another exemplary embodiment.

FIG. 13 is a block diagram illustrating the deployable refuse collection vehicle of FIG. 12, according to an exemplary embodiment.

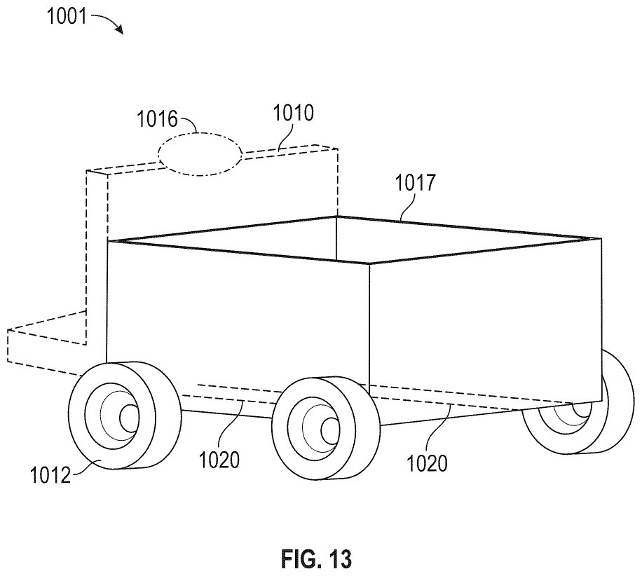

FIG. 14 is a diagram illustrating the deployable refuse collection vehicle of FIG. 12 in a stored configuration with the refuse vehicles of FIGS. 1-3, according to an exemplary embodiment.

FIG. 15 is a diagram illustrating the deployable refuse collection vehicle of FIG. 12 in a deployed configuration with the refuse vehicles of FIGS. 1-3, according to an exemplary embodiment.

FIG. 16 is a perspective view of the deployable refuse collection vehicle of FIG. 12 including a grabber apparatus, according to an exemplary embodiment.

FIG. 17 is a flow chart of a process of operating the deployable refuse collection vehicle of FIG. 16 with the refuse vehicles of FIGS. 1-3, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a deployable refuse collection vehicle may be interoperable with a refuse collection vehicle. The deployable refuse collection vehicle may couple to the refuse collection vehicle via a deployable vehicle dock. In this way, the deployable refuse collection vehicle may receive power and/or charge a battery via the refuse collection vehicle. When deployed, the deployable refuse collection vehicle may engage refuse cans with a grip or grabber apparatus. Beneficially, the deployable refuse collection vehicle may remotely, autonomously, or semi-autonomously stage and/or arrange refuse cans such that they are readily retrievable by the refuse collection vehicle. Additionally, the deployable refuse collection vehicle may include a refuse container that may interchangeably couple to the refuse vehicle and the deployable refuse collection vehicle. Beneficially, an operator may deploy the deployable refuse collection vehicle having a refuse container and may navigate it separately from the refuse collection vehicle. The deployable refuse collection vehicle may have a smaller profile, produce less noise, require less energy, and place personnel in less danger by autonomously navigating to collect refuse and return collected refuse to the refuse collection vehicle. Further, the deployable refuse collection vehicle may access areas that the refuse collection vehicle may not be able to enter, such as narrow alleys, neighborhoods with noise restrictions, and the like, thereby increasing the scope of a refuse collection operation.

### Refuse Vehicle

### Front-Loading Configuration

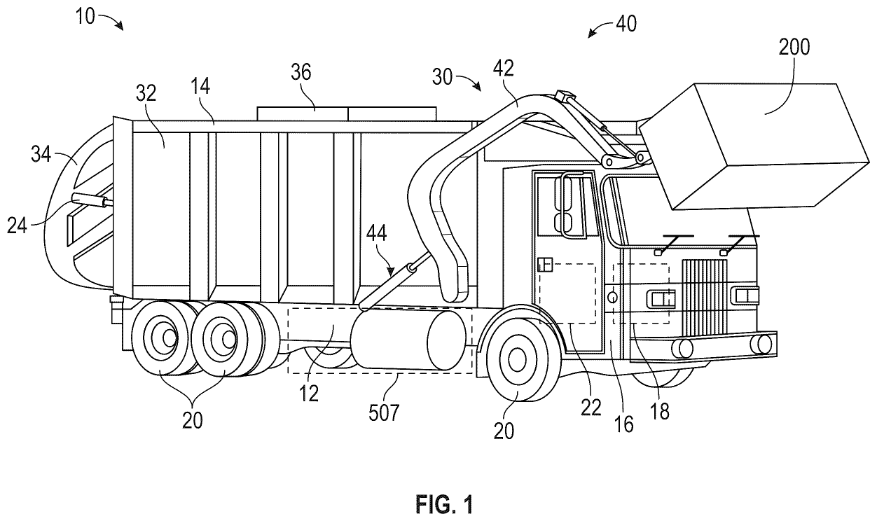

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotably coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotably coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

As shown in FIG. 1, the refuse vehicle 10 includes a deployable vehicle dock 507. The deployable vehicle dock 507 is configured to receive and store a deployable refuse collection vehicle (“DRCV”). For example, the deployable vehicle dock 507 may include a recess, designated space, mounting, compartment, or other structure built in or affixed to the refuse vehicle 10. The deployable vehicle dock 507 may be configured to store a DRCV or components thereof beneath the refuse vehicle 10, on the side of the refuse vehicle 10, or at any other sufficient section of the refuse vehicle 10. The deployable vehicle dock 507 may be coupled to the one or more systems of the refuse vehicle 10. For example, the deployable vehicle dock 507 may include one or more power connectors that draws power from the engine 18 or a battery stored on the refuse vehicle 10. The power connectors may electrically couple to one or more DRCVs to charge the DRCVs while they are stored on the refuse vehicle, are not in use, etc.

### Rear-Loading Configuration

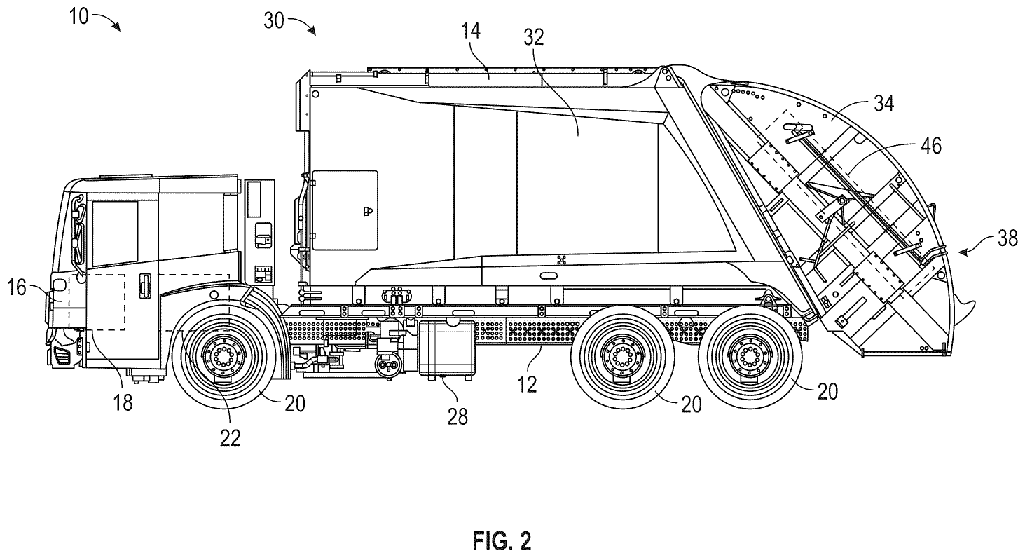

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

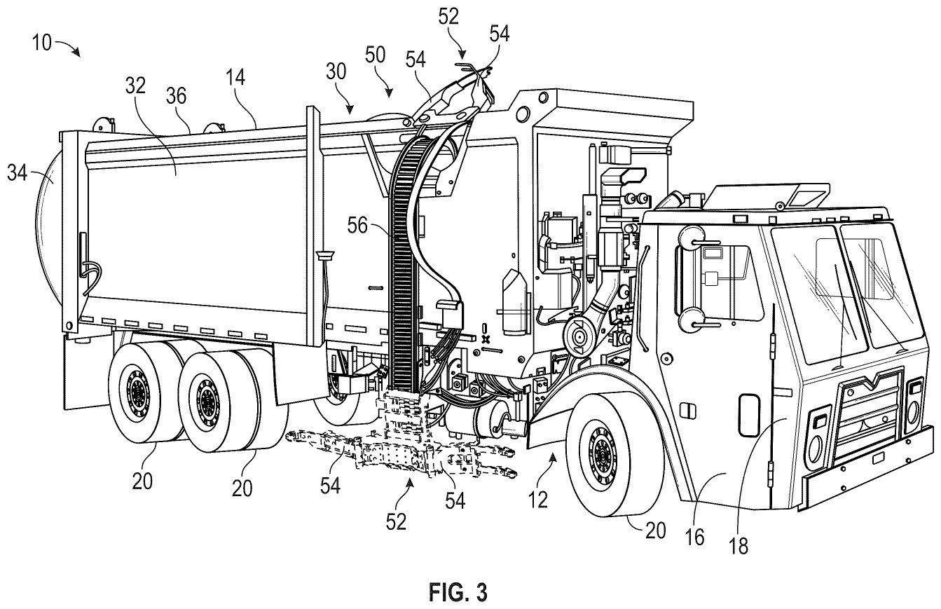

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

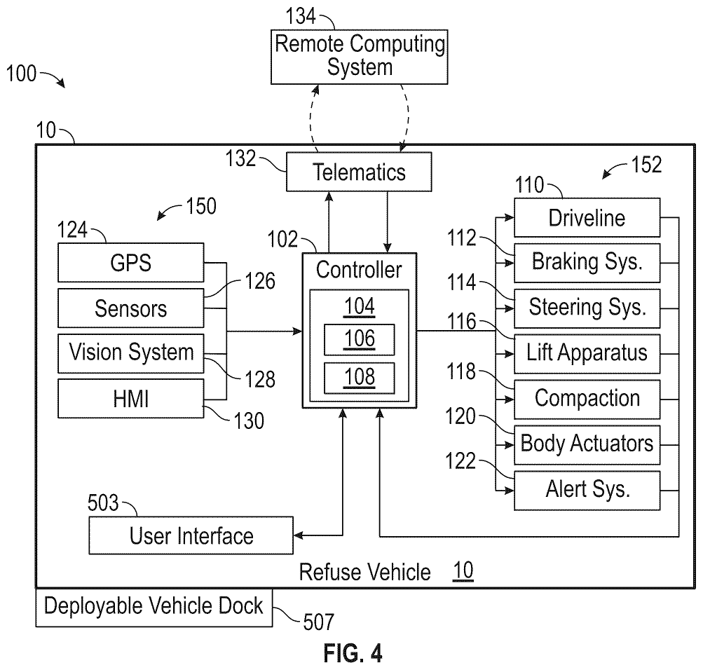

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

The refuse vehicle 10 may include a user interface 503. The user interface 503 allows user inputs to be received and communicated to one or more DRCVs. Further, the user interface 503 may communicate data, images, or messages related to one or more DRCVs. For example, the user interface 503 may include a display screen, a touch screen, a controller, a joystick, a keyboard, one or more dials, knobs, switches, or the like. As discussed herein, the user interface 503 may allow for an operator to toggle between a remote mode (e.g., where the DRCV is controlled by the operator via a controller, where the operator directly drives or operates the DRCV), an autonomous mode (e.g., where the DRCV operates substantially independently based on instructions and/or programming stored in its memory, etc.), and/or semi-autonomously (e.g., where the DRCV operates substantially independently while an operator observes and may make corrective/overriding actions). Further, the user interface 503 may include on or more display devices such as LCD screens, mobile phones, applications, etc. to display information related to the DRCVs. The information may include camera feed or image data received from the DRCV, GPS data related to the DRCV, battery level of the DRCV, weight of refuse currently loaded on the DRCV, or the like.

The controller 102 may be communicatively, electrically, or otherwise coupled to the deployable vehicle dock 507. In this way, the controller 102 may direct power to the deployable vehicle dock 507 (e.g., to charge a DRCV upon receiving an indication that the DRCV is connected to a power connector of the deployable vehicle dock 507). The controller 102 may also display a connection status regarding the deployable vehicle dock, cause one or more DRCVs to couple/de-couple from the deployable vehicle dock 507, or the like.

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

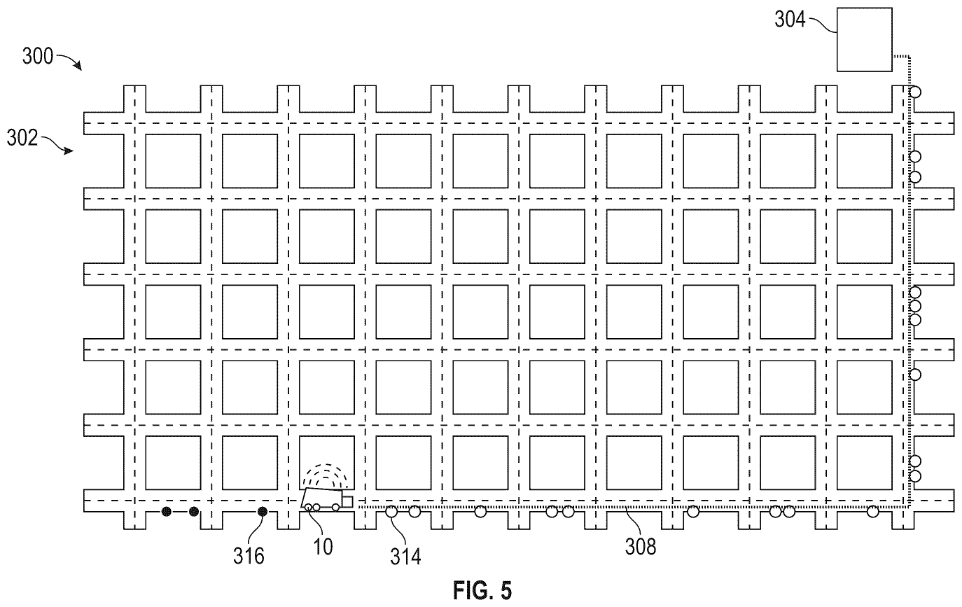

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Deployable Refuse Collection System

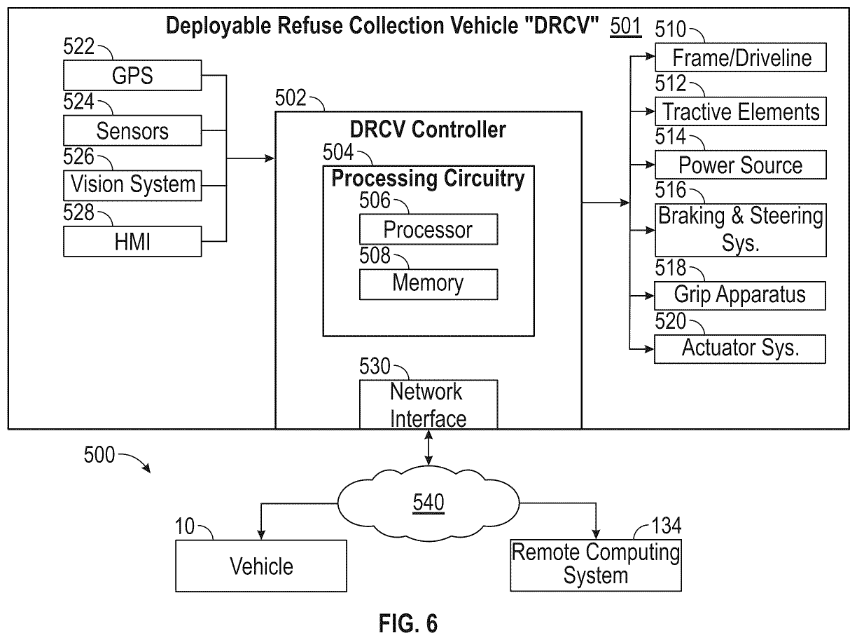

Referring to FIG. 6, a refuse collection system 500 is shown that includes the refuse vehicle 10 and a DRCV 501 (e.g., a drone, a robot, an autonomous machine, etc.). The refuse collection system 500 may also include a remote computing system 134 through which commands, data, and the like are transmitted to and from the refuse vehicle 10 and the DRCV 501 via a network 540. The network 540 may be any type of network (e.g., intranet, Internet, VPN, a cellular network, a satellite network, etc.) that allows the refuse vehicle 10 and/or the DRCV 501 to communicate with other remote systems. For example, vehicle 10 and/or DRCV 501 may communicate with a server (e.g., a computer, a cloud server, etc.) to send and receive information regarding operations of the DRCV 501 and/or the refuse vehicle 10.

As shown in FIG. 6, the DRCV 501 includes various input devices such as a Global Positioning System (“GPS”) 522, one or more sensors 524, a vision system 526 (e.g., an awareness system), and a Human Machine Interface (“HMI”) 528. The DRCV 501 also includes various controllable elements such as a deployable frame/driveline 510, tractive elements 512, a power source 514, a braking and steering system 516, a grip apparatus 518 (e.g., a robotic arm, a lift assembly, a forklift connector, a grabber mechanism, etc.), and/or an actuator system 520 (e.g., actuators to control the grip apparatus 518, actuators to couple/decouple the DRCV 501 to/from the refuse vehicle 10, actuators to fold/condense the frame 510 for storage, etc.).

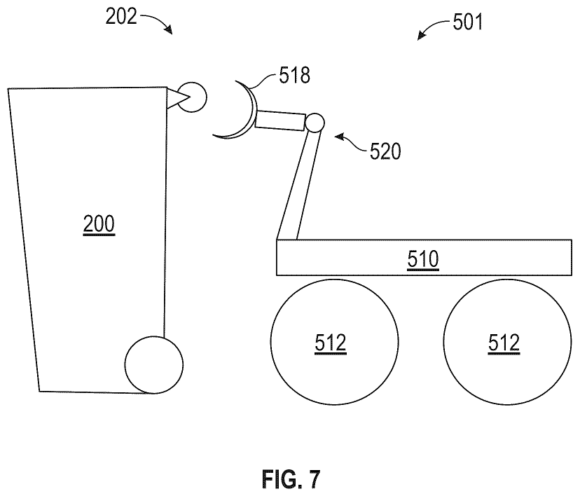

Referring to FIGS. 6 and 7, the frame 510 may provide a structural foundation around which the other components of the DRCV 501 are coupled. The frame 510 may be composed of steel, metals, composite materials, or other suitable components to be deployed and collect, haul, lift, etc. refuse/refuse cans, etc. The frame 510 may include a built-in driveline that includes components such as a transmission, gears, a prime mover (e.g., an electric motor), and other suitable components. Further, the frame 510 may be configured to transition between a storage state and a deployed state. In the storage state, the frame/driveline 510 may condense down, disassemble, fold together, flatten, etc. and reduce its size/profile. For example, connectors, hinges, or other bars/members of the frame 510 may slidably engage and disengage to flatten the frame or condense the frame down to a block, panel, or other suitable shape. In some embodiments, components of the DRCV 501 telescopically extend or collapse to deploy/store the DRCV 501. While in the storage state, the frame/driveline 510 may be lifted, coupled, and/or stored on the refuse vehicle 10. For example, as shown in FIG. 7, the grip apparatus 518 and the actuator system 520 (e.g., a gripping arm or extension) may fold or collapse backward into a channel, pocket, or other compartment defined in the frame 510. Further, the frame/driveline 510 and other components of the DRCV 501 may mount to or fit within the deployable vehicle dock 507 while in the storage state. While in the deployed state, the frame/driveline 510 may be assembled, fully extended, or otherwise configured such that the DRCV 501 may navigate and operate to collect and engage with refuse cans, such as the refuse can 200 shown in FIG. 7.

The tractive elements 512 may include wheels, tracks, or other suitable attachments to allow the DRCV 501 to navigate from the refuse vehicle 10 to one or more refuse cans 200.

The power source 514 can provide power to the DRCV 501 and the components of the thereof. The power source 514 can be embedded into or attached on to the frame 510. The power source 514 may include a battery. The battery may be a rechargeable or non-rechargeable type including an alkaline battery, a nickel-cadmium battery, a nickel-metal hydride battery, a lithium-ion battery, or a lead-acid battery. In a preferred embodiment, the power source 514 is a battery which can be recharged using an interface such as a power connector, plug, etc. configured to couple to a power conduit or connector of the deployable vehicle dock 507 of the refuse vehicle 10. Additionally, the power source 514 may be charged separate from the refuse vehicle 10 via a charger, generator, or the like.

The braking and steering system 516 allows the DRCV 501 to navigate and change its path or direction in response to inputs, such as commands or signals from an operator via a remote or commands or signals from a DRCV controller 502 as discussed herein.

Referring to FIGS. 6, 7, and 8, the grip apparatus 518 allows the DRCV 501 to engage with refuse cans, collection bins, corals, doors, gates, and other structures to assist in a refuse collection operation. For example, as shown in FIG. 7, the grip apparatus 518 includes a claw or grasping member, which is configured to engage or grip a handle 202 of the refuse can 200. In this way, the DRCV 501 may engage and move the refuse can 200 to a staging location such as a curb side, a location readily accessible to a refuse vehicle 10, etc. In some embodiments, a staging area may be selected by an operator via a user interface 503 of the refuse vehicle 10, a map, a GPS unit, or the like, and the DRCV 501 may locate the refuse cans 200 once deployed and line the refuse cans 200 along a route for collection by the refuse vehicle 10. In other embodiments, the grip apparatus 518 may prepare or access a commercial container or other compartment. For example, the grip apparatus 518 may open corral doors, stage carts, move debris, position carts away from obstructions, overhead powerlines, or other obstacles, etc.

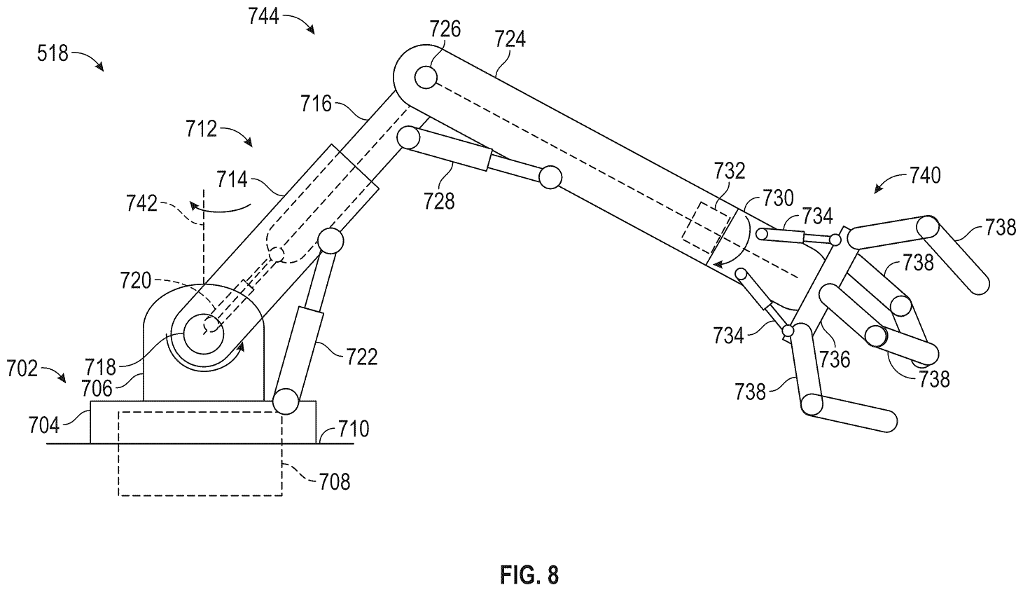

As shown in FIG. 8, the grip apparatus 518 includes a robotic arm implement having a base portion 702 that is pivotably coupled with a base surface 710 (e.g., a portion of the frame 510) through a pivotable or rotatable coupler 704. The robotic arm implement may include a rotary actuator 708 (e.g., an electric motor) configured to drive rotation of the robotic arm implement about a corresponding axis 742 that extends through the rotatable coupler 704 in either direction. The base portion 702 also includes a pivotable coupling 706 defining a pivot point 718. The pivotable coupling 706 is coupled with the rotatable coupler 704. An arm assembly 744 is coupled with the base portion 702 at the pivot point 718. The arm assembly 744 is shown to include a first boom section 712 and a second boom section 724 but may include any number of boom sections as required in order to provide sufficient reach. The first boom section 712 may be a telescoping member including an outer member 714 that is pivotably coupled at a first end with the pivot point 718, and an inner member 716 that is received within the outer member 714 and can translate relative to the outer member 714 in order to extend or retract the first boom section 712. The robotic arm implement may include a first actuator 722 (e.g., of the actuator system 520) that is coupled at a first end with the outer member 714 and at an opposite end with the rotatable coupler 704. The first actuator 722 is configured to extend or retract to drive the arm assembly 744 to rotate about the pivot point 718. The first boom section 712 may include an extension actuator 720 that is configured to extend or retract to drive the extension or retraction of the first boom section 712 (e.g., to drive the inner member 716 to translate relative to the outer member 714).

The second boom section 724 is pivotably coupled with an end of the inner member 716 at a pivot point 726. The second boom section 724 may be driven to rotate about the pivot point 726 by extension or retraction of a second actuator 728. The second boom section 724 can be rotatably coupled with an end portion 730. The end portion 730 may be driven to rotate relative to the second boom section 724 about an axis extending lengthwise through the second boom section 724 by a rotary actuator 732. The rotary actuator 732 may be similar to the rotary actuator 708. The robotic arm implement may also include a claw assembly 740 that is coupled with the second boom section 724. The claw assembly 740 may include a carriage 736 that is pivotably coupled with the end portion 730 and is configured to be driven to rotate (e.g., pivot, hinge, swivel, etc.) relative to the end portion 730 by third actuators 734. The claw assembly 740 can include multiple fingers 738, each including articulable sections pivotably coupled with each other and driven to articulate to grasp or release an object by operation of corresponding actuators.

Still referring to FIGS. 6, 7, and 8, the actuator system 520 may include one or more actuators of the DRCV 501. For example, the actuator system 520 may control engagement, positioning, and deployment of the grip apparatus 518. Further actuators may be used to extend or condense the DRCV 501 from the storage state to the deployed state. In other embodiments, actuators of the actuator system 520 may adjust the height/incline of the frame 510 of the DRCV 501 to access varied refuse cans 200, may operate to switch from one grip apparatus 518 to another (e.g., rotate an assembly to exchange a robotic arm for a tipper engagement arm, forklift engagement arm, or the like).

The sensors 524 may include image/object sensors (e.g., any type of device that is configured to capture data associated with the detection of objects such as refuse cans). The sensors 524 may include any type of image and/or object sensors, such as one or more visible light cameras, full-spectrum cameras, LIDAR cameras/sensors, radar sensors, infrared cameras, image sensors (e.g., charged-coupled device (CCD), complementary metal oxide semiconductor (CMOS) sensors, etc.), or any other type of suitable object sensor or imaging device. Data captured by the sensors 524 may include, for example, raw image data from one or more cameras (e.g., visible light cameras) and/or data from one or more sensors (e.g., LIDAR, radar, etc.) that may be used to detect objects.

Generally, the sensors 524 may be disposed at any number of locations throughout and/or around the DRCV 501 for capturing image and/or object data from any direction. For example, the sensors 524 may include a plurality of visible light cameras and LIDAR cameras/sensors mounted on the forward and lateral sides of DRCV 501 for capturing data as the DRCV 501 moves down a path (e.g., a roadway). In some embodiments, one or more of the sensors 524 may be located on an attachment utilized by DRCV 501, such as the grip apparatus 518 described above. The sensors 524 can also include a radio frequency identification (RFID) detector (e.g., an RFID reader, an RFID transponder, etc.) that is configured to wirelessly transmit energy to proximate RFID tags. The RFID detector may monitor responses that are received from nearby RFID tags. In particular, the refuse containers 200 may include RFID tags that are configured to provide a response signal to the RFID detector. The RFID detector may be positioned on the grip apparatus 518 or on an exterior surface of the DRCV 501 such that the RFID detector is sufficiently close to the refuse containers 200 to communicate with RFID tags. The sensors 524 may also include separate QR code scanners or barcode scanners positioned on the grip apparatus 518 (e.g., on the claw assembly 740) or on a side of the DRCV 501.

The vision system 526 may include a detection system, an environmental detection system, an environmental awareness system, etc. that is configured to detect and identify the environment surrounding the DRCV 500. The environment may include adjacent objects, approaching objects, lane lines, obstacles, drivable surfaces, etc. The vision system 526 may be configured to detect different types of objects such as refuse containers, the refuse vehicle 10, other vehicles, pedestrians, buildings, or any other object that may be adjacent the DRCV 501. The vision system 526 may use a variety of sensors, detectors, emitters, detection sub-systems, etc., to detect different types of objects. In some embodiments, the vision system 526 may include radar sensors with sensing arcs configured to detect objects in the surrounding area of the DRCV 501. In some embodiments, the radar sensors are positioned on the exterior of the DRCV 501 such that the sensing arcs of the radar sensors overlap to generate a 360-degree sensing area. In some embodiments, the radar sensors are a combination of long and short-range sensors. According to some embodiments, the vision system 526 may include camera sensors with sensing arcs. In some embodiments, the camera sensors may include a visible light camera, infrared light camera, LiDAR sensor, radar sensor, ultrasonic sensor, and/or time-of-flight camera, which may be positioned on the exterior of the DRCV 501 such that the sensing arcs of the camera sensors overlap to generate a 360-degree sensing area. In some embodiments, the camera sensors are a combination of narrow-angle sensors and wide-angle sensors. In additional embodiments, the vision system 526 may include a combination of the radar sensors with the sensing arcs and the camera sensors with sensing arcs. The sensing arcs of the radar sensors and the sensing arc of the camera sensors may combine to provide 360 or near-360-degree coverage of the perimeter of the DRCV 501.

The HMI 528 may include a control panel, joystick, controller, keyboard, mouse, switches, or other device enabling operation of and allowing commands to be sent to the DRCV 501. In this way, an operator may drive, pilot, or otherwise navigate the DRCV 501, for example, while in the cab 16 of the refuse vehicle 10. In other embodiments, a switch, dial, or the like of the user interface 503 of the refuse vehicle 10 may toggle a control mode that communicatively couples the controls of the refuse vehicle 10 to the controls of the DRCV 501. In this way, the operator may use, for example, the steering wheel/joystick of the refuse vehicle 10, a screen or dashboard display, and other components of the refuse vehicle 10 to operate and navigate the DRCV 501. The HMI 528 may include a display device, a screen, or other indicator to display a camera feed, video feed, or other GUI associated with or captured by the DRCV 501. In this way, while deployed, an operator may monitor, control, and/or guide the operation of the DRCV 501, for example, to locate the refuse cans 200 and position them at staging areas for collection. In other embodiments, the DRCV 501 may operate autonomously and display one or more statistics, data sets, information sets, battery conditions, or the like to a user interface (e.g., user interface 503 of the refuse vehicle 10). For example, the DRCV 501 may generate a map, route, or list indicating locations of the refuse cans 200, streets with no refuse cans, a total number of refuse cans aligned, a battery level remaining, a battery level or charging state of a stored DRCV 501, etc.

As shown in FIG. 6, the DRCV 501 includes a DRCV controller 502 that is configured to facilitate remote, autonomous, or semi-autonomous operation of the DRCV 501, or components thereof. The DRCV controller 502 may be positioned on the DRCV 501. In some embodiments, the DRCV controller 502 includes one or more components located in different places. For example, one or more components or circuits associated with the DRCV controller 502 may be located on the remote computing system 134, on the telematics unit 132 of the refuse vehicle 10, etc.

The DRCV controller 502 includes processing circuitry 504 including a processor 506 and memory 508. Processing circuitry 504 can be communicably connected with a communications interface of DRCV controller 502 such that processing circuitry 504 and the various components thereof can send and receive data via the communications interface. Processor 506 can be implemented as a general-purpose processor, an ASIC, one or more FPGAs, a group of processing components, or other suitable electronic processing components.

Memory 508 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 508 can be or include volatile memory or non-volatile memory. Memory 508 can include database components, object code components, script components, or any other type of information structure for supporting the various activities and information structures described in the present application. According to some embodiments, memory 508 is communicably connected to processor 506 via processing circuitry 504 and includes computer code for executing (e.g., by at least one of processing circuitry 504 or processor 506) one or more processes described herein.

The DRCV controller 502 is configured to receive inputs (e.g., measurements, detections, signals, sensor data, etc.) from the GPS 522, the sensors 524, the vision system 526, HMI 528, the refuse vehicle 10, and/or the remote computing system 134, according to some embodiments. In particular, the DRCV controller 502 may receive a GPS location from the GPS system 522 (e.g., current latitude and longitude of the DRCV 501). The DRCV controller 502 may receive sensor data (e.g., refuse can 200 location, obstacle location, battery power level, speed of the DRCV 501, weight carried/hauled/pulled by the DRCV 501, etc.) from the sensors 524. The DRCV controller 502 may receive image data (e.g., real-time camera data) from the vision system 526 of an area of the DRCV 501 (e.g., in front of the DRCV 501, rearwards of the DRCV 501, on a street-side or curbside of the DRCV 501, at the grip apparatus 518 of DRCV 501 to monitor engagement with a refuse can 200, corral door, or object, etc.). The DRCV controller 502 may receive user inputs from the HMI 528 and/or the user interface 503 (e.g., button presses, requests to perform a lifting or loading operation, driving operations, steering operations, braking operations, etc.).

The DRCV controller 502 may be configured to provide control outputs (e.g., control decisions, control signals, etc.) to the driveline 510 (e.g., the electric motor, etc.) to operate the driveline 510 to transport the DRCV 501. The DRCV controller 502 may also be configured to provide control outputs to the braking and steering system 516 to activate and operate the braking system 516 to decelerate the DRCV 501 (e.g., by activating a friction brake system, etc.). Control outputs may additionally operate the braking and steering system 516 to rotate or turn at least two of the tractive elements 512 to steer the DRCV 501. The DRCV controller 502 may also be configured to operate actuators or motors of the grip apparatus 518 and the actuator system 520 (e.g., claw assembly or arm actuators) to perform a lifting/hauling/dragging/can engagement operation (e.g., to grasp, pull, and return a refuse container).

The DRCV controller 502 may also be configured to receive feedback from any of the frame/driveline 510, the braking and steering system 516, the power source 514, the grip apparatus 518, or the actuator system 520. The DRCV controller 502 may provide any of the feedback to the remote computing system 134, the telematics unit 132, and/or the refuse vehicle 10.

The DRCV controller 502 is configured to use any of the inputs from any of the GPS 522, the sensors 524, the vision system 526, the HMI 528, the user interface 503, etc. to generate controls for the driveline 510, the steering and braking system 516, the grip apparatus 518, the actuator system 520. In some embodiments, the DRCV controller 502 is configured to operate the driveline 510, the steering and braking system 516, the grip apparatus 518, and the actuator system 520 to autonomously transport the DRCV 501 along a route (e.g., self-driving), perform refuse can staging operations or refuse collection engagement operations autonomously, and transport empty refuse cans 200 to a return area. The DRCV controller 502 may receive one or more inputs from the remote computing system 134 such as route data, indications of pickup locations along the route, route updates, customer information, pickup types, etc. The DRCV controller 502 may use the inputs from the remote computing system 134 to autonomously transport the DRCV 501 along the route and/or to perform the various operations along the route (e.g., staging and locating refuse containers 200, etc.).

The DRCV controller 502 may include a network interface 530. The processing circuitry 504 can be communicably connected to the network interface 530 such that processing circuitry 504 and the various components thereof can send and receive data (e.g., camera data to a display device of the refuse vehicle 10). In some embodiments, the DRCV controller 502 is communicably coupled with the network 540 via the network interface 530, for transmitting data to and/or receiving data from network connected devices. Network interface 530 may include any type of wireless interface (e.g., antennas, transmitters, transceivers, etc.) for conducting data communications with the network 540. In some embodiments, the network interface 530 includes a cellular device configured to provide DRCV controller 502 with Internet access by connecting the DRCV controller 502 to a cellular tower via a 2G network, a 3G network, 4G network, a 5G network, an LTE network, etc. In some embodiments, the network interface 430 includes other types of wireless interfaces such as Bluetooth, WiFi, Zigbee, etc.

In some embodiments, the DRCV controller 502 is configured to receive over-the-air (OTA) updates or other data from a remote system (e.g., a server, a computer, etc.) via the network 540. The OTA updates may include software and firmware updates for the DRCV controller 502, for example. Such OTA updates may improve the robustness and performance on the DRCV controller 502. In some embodiments, the OTA updates are received periodically to keep the DRCV controller 502 up-to-date.

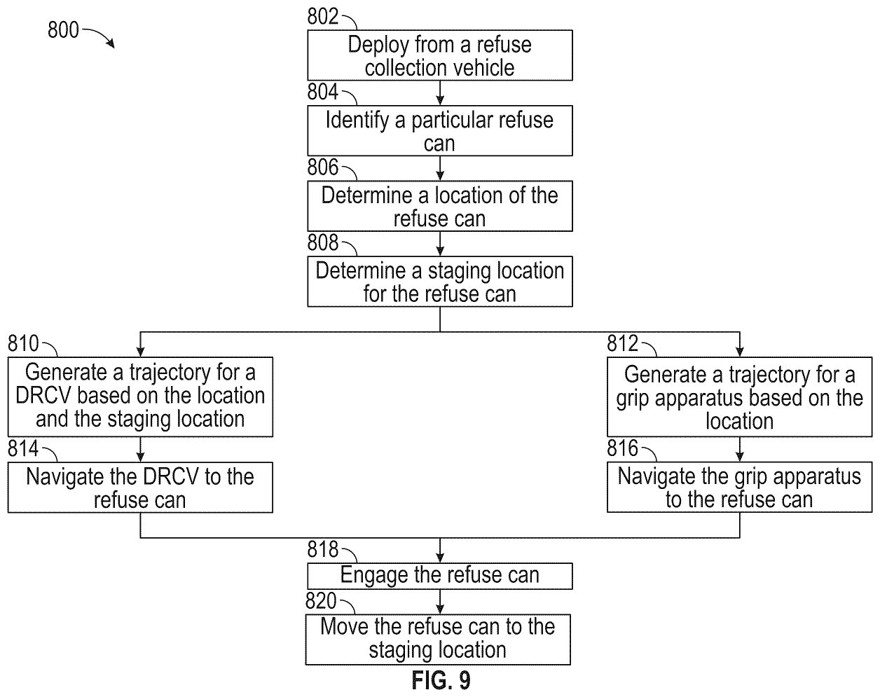

Turning to FIG. 9, a process 800 for utilizing the refuse collection system 500 is shown, according to some embodiments. Process 800 may be implemented by an operator of a refuse vehicle 10 (e.g., via a user interface 503, by manually uncoupling and deploying the DRCV 501, etc.) at the start of a refuse collection operation. Process 800 may be wholly or partially implemented by the controller 102 of the refuse vehicle 10 and/or the DRCV controller 502.

At step 802, the DRCV 501 is deployed, for example, from the deployable vehicle dock 507 of the refuse vehicle 10. In some embodiments, an operator exits the cab 16 of the refuse vehicle 10 to unload, unmount, decouple, or otherwise retrieve the DRCV 501 from the deployable vehicle dock 507. The operator may unplug a power connector or conduit from a charging port of the deployable vehicle dock 507. In other embodiments, a signal (e.g., from the controller 102, from the user interface 503, etc.) initiates a process to automatically decouple or deploy the DRCV 501 from the refuse vehicle 10. In some embodiments, the DRCV 501 is removed from the refuse vehicle 10, transitioned from a stored state to a deployed state, and begin operations. For example, the frame 510 of the DRCV 501 may be telescopically extended, assembled, unfolded, or otherwise configured to begin a refuse collection operation.

At step 804, a particular refuse can 200 is identified. The DRCV 501 may identify multiple objects including multiple refuse cans 200. In order to initiate an engagement action, the particular refuse can 200 may be identified, either automatically or based on a user input. In the first case, where the particular refuse can 200 is automatically identified in order to initiate an engagement action, a controller (e.g., DRCV controller 502) may implement a number of parameters for identifying the particular refuse can 200. For example, the refuse can 200 may be identified based on identifying features (e.g., size, color, shape, logos or markings, etc.) or may be selected based on its proximity to the refuse vehicle 10 (e.g., the closest refuse can may be identified first). In other embodiments, the particular refuse can 200 may be located based on a displacement from a staging zone or a loading zone (e.g., located 5 feet or more from the curbside, etc.). The particular refuse can 200 may be automatically identified in autonomous operations (e.g., where DRCV 501 is autonomous) in order to reduce or eliminate operator input.

In some embodiments (e.g., semi-autonomous or non-autonomous operations), the particular refuse can 200 may be selected by an operator. As described above, for example, the operator may be presented with the user interface 503 and/or HMI 528 for viewing captured data (e.g., image data) and identified objects. The operator may select, from the user interface, the particular refuse can 200. Using user interface 503 as an example, the operator may select one of the refuse cans 200, in order to initiate collection of the particular refuse can 200.

At step 806, a location of the identified refuse can 200 is determined. In some embodiments, the location of the refuse can 200 may be determined based on the location of the refuse vehicle 10 and/or the DRCV 501. In some embodiments, sensor data from the sensors 524 may be used to determine the location of the identified refuse can 200. For example, data from LIDAR or radar sensors may be used to determine a location of the refuse can 200, and/or may be used to supplement other data (e.g., from a visible light camera).

At step 808, staging locations for one or more particular refuse cans 200 are determined. For example, in autonomous or semi-autonomous operations, the DRCV 501 may navigate and identify a particular refuse can 200 and its location. The DRCV 501 (e.g., via the DRCV controller 502) may determine based on the location of the particular refuse can 200 that the particular refuse can 200 should be moved to a staging location. For example, the DRCV 501 may determine (e.g., via sensors 524) that the refuse can 200 is too far from a curbside for the refuse vehicle 10 to collect, is located under overhead obstacles that would prevent the refuse vehicle 10 for lifting the refuse can 200, etc. Accordingly, the DRCV 501 may identify a clear or open location (e.g., an unoccupied space near the curbside) and identify the location as a staging location for the particular refuse can 200. In other embodiments, (e.g., remote embodiments) the operator may identify a zone, a location, or a region as a target staging zone and instruct the DRCV 501 to transport or move the particular refuse can 200 to the identified staging zone. In this way, the operator may stage and set the location for the refuse cans 200 along a particular route before navigating the refuse vehicle 10 along the route.

At step 810, a trajectory is generated for the DRCV 501 based on the location of the refuse can 200. Simultaneously, at step 812, a trajectory is generated for the grip apparatus 518 of the DRCV 501. The trajectories for the DRCV 501 and the grip apparatus 518 may indicate a path that the corresponding systems follow to reach and engage the refuse can 200. The trajectory of the DRCV 501, for example, may indicate a path or a set of movements for the DRCV 501 to follow to move next to the refuse can 200 so that the grip apparatus 518 may move to engage the refuse can 200. Similarly, the trajectory of the grip apparatus 518 may indicate a path or a set of movements that the grip apparatus 518 may follow to engage the refuse can 200 (e.g., via a handle of the refuse can 200, via a tipper engagement point, etc.) once the refuse vehicle 10 has moved alongside the refuse can 200. Further, the DRCV 501 may determine an appropriate grip apparatus 518 and toggle/switch to that grip apparatus based on an identification of the particular refuse can 200. For example, in some embodiments, the refuse can 200 may have a broken handle, no handle, or only have a tipper and/or forklift engagement portion. Accordingly, the DRCV 501 may approach the refuse can 200 after switching or rotating the grip apparatus 518 to a tipper engagement portion or a forklift engagement portion.

At steps 814 and 816, the DRCV 501 and the grip apparatus 518 navigate (e.g., move) to the refuse can 200. In autonomous and/or semi-autonomous operations, the DRCV 501 and the grip apparatus 518 may be controlled or commanded (e.g., by DRCV controller 502) to automatically navigate to the refuse can 200. For example, the DRCV 501 may automatically move to the refuse can 200, and the grip apparatus 518 may automatically move to engage the refuse can 200, without operator input. In other embodiments, the trajectories generated at steps 810 and 812 may be presented to the operator (e.g., via user interface 503) so that the operator may navigate the DRCV 501 and/or the grip apparatus 518 to the refuse can 200. As an example, the trajectories may be presented via a user interface, indicating a path and/or movements that the operator should follow to navigate to the refuse can 200. The operator may then utilize a controller, a joystick, etc. to control the DRCV 501 and/or the grip apparatus 518 to follow the path/movements to engage and stage the refuse can 200.

In some embodiments, as the DRCV 501 and/or the grip apparatus 518 navigate (e.g., move) towards the refuse can 200, image data and/or sensor data may be captured from the various subsystems of the DRCV 501 and/or from the grip apparatus 518. The captured image and/or sensor data may be transmitted to the remote computing system 134, the vehicle 10, the telematics unit 132, etc. in order to improve, modify, and/or otherwise adjust the movements of the DRCV 501 and/or the grip apparatus 518.

At step 818, the refuse can 200 is engaged by the grip apparatus 518. The refuse can 200 may be engaged by moving the grip apparatus 518 in any suitable direction to engage and grip the refuse can 200. For example, the grip apparatus 518 may move horizontally, vertically, and/or orthogonally to the DRCV 501 in order to engage the refuse can 200. Once the grip apparatus 518 has secured the refuse can 200 (e.g., by closing actuators), at step 820, the grip apparatus 518 and the DRCV 501 may drag, pull, or otherwise move the refuse can 200 to the staging location. In other embodiments, the DRCV 501 and/or the grip apparatus 518 may interact with other commercial products (e.g., corral doors), debris, discarded/spilled refuse and engage with the object to assist in the refuse collection operation.

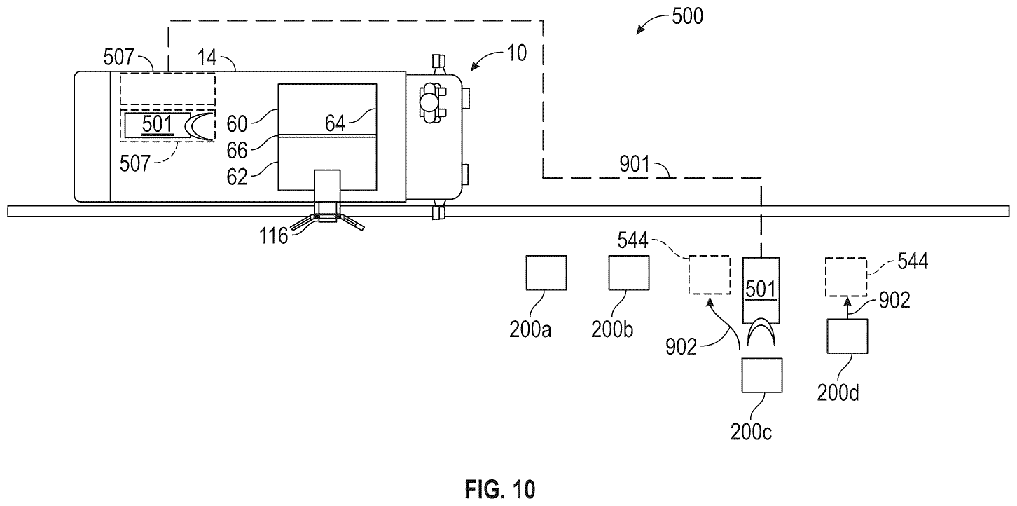

As shown in FIG. 10, the refuse vehicle 10 may have multiple deployable vehicle docks 507 such that two or more DRCVs 501 may be stored/equipped to the refuse vehicle 10. In this way, while one DRCV 501 operates, the other DRCV 501 may charge its battery, receive maintenance, etc. Alternatively, some or all of the DRCVs 501 may simultaneously operate to assist in the refuse collection operation. As shown in FIG. 10, one DRCV 501 has been deployed and has travelled along generated trajectory 901 to a specific refuse can 200c. The DRCV 501 has also identified a staging location 544 associated with the specific refuse can 200c. The staging location 544 may be determined, for example, based on a fixed distance from the curbside to the staging location 544, based on a linear or predefined path from previous refuse cans 200a, 200b (e.g., to line up multiple refuse cans), or based on a detection of an obstacle that would prevent the refuse vehicle 10 from lifting/emptying refuse can 200c (e.g., identifying overhead wires, limbs, structures, etc. above refuse can 200c). Accordingly, the DRCV 501 may engage refuse can 200c via the grip apparatus 518. The DRCV 501 may then move refuse can 200c along generated pathway 902 to deliver the refuse can 200c to the staging location 544. The DRCV 501 may repeat this process with respect to refuse can 200d, second staging location 544, and second generated pathway 902. In additional embodiments, once the refuse vehicle 10 has emptied the refuse can 200, the DRCV 501 may be configured to return the refuse can 200 to a target location (e.g., to a customer's garage, to a location a customer designates via a remote computer connected to the network 540, etc.).

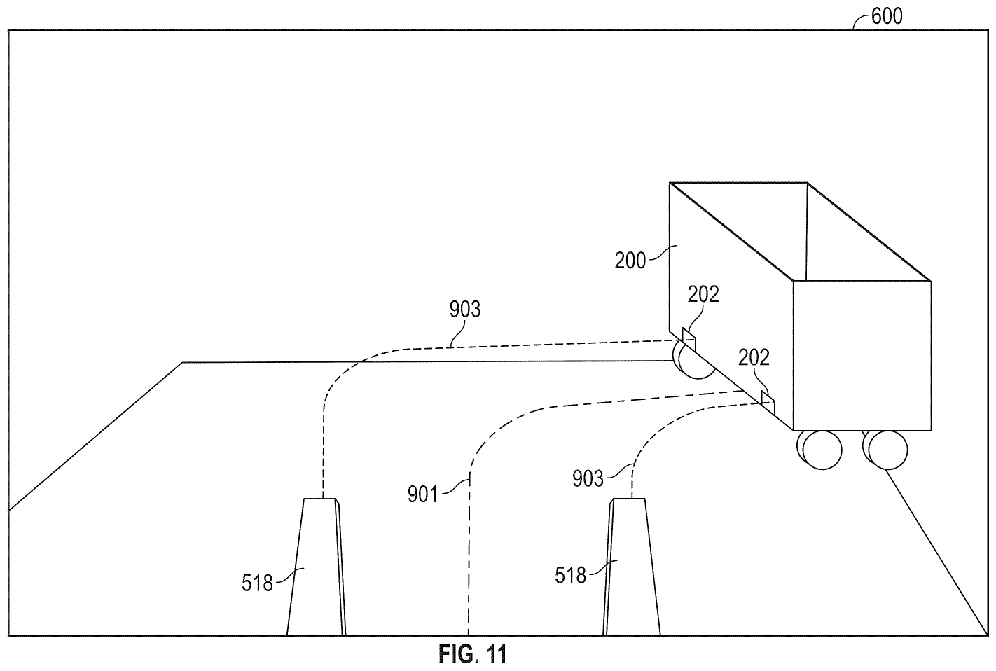

Turning to FIG. 11, a graphical user interface (GUI) 600 that can be generated by the user interface 503, the HMI 528, and/or one or more controllers (e.g., the controller 102, the DRCV controller 502) is shown. The GUI 600 may be displayed on the user interface 503 and includes image data and route display data. The image data may be image data obtained from a camera at a front of the DRCV 501. The route display data can include a DRCV path (e.g., generated trajectory 901) and a grip apparatus path 903 that are superimposed over the image data that is obtained from the camera at the front of the DRCV 501. The DRCV path (e.g., generated trajectory 901) and grip apparatus path 903 visualizations are shown guiding the DRCV 501 to the refuse container 200 such that the grip apparatus 518 (here, forks) are received within the pockets 202 of the refuse container 200. The operator may navigate (e.g., via the user interface 503) the DRCV 501 along the paths displayed in FIG. 11. In some embodiments, the user interface 503 on which the GUI 600 is displayed is integrated into a dashboard of the refuse vehicle 10 or the windshield of the refuse vehicle 10 such that the user interface 503 provides an augmented reality type display of the DRCV path (e.g., generated trajectory 901) and the grip apparatus path 903 visualizations.

### Deployable Self-Propelled Carry Can

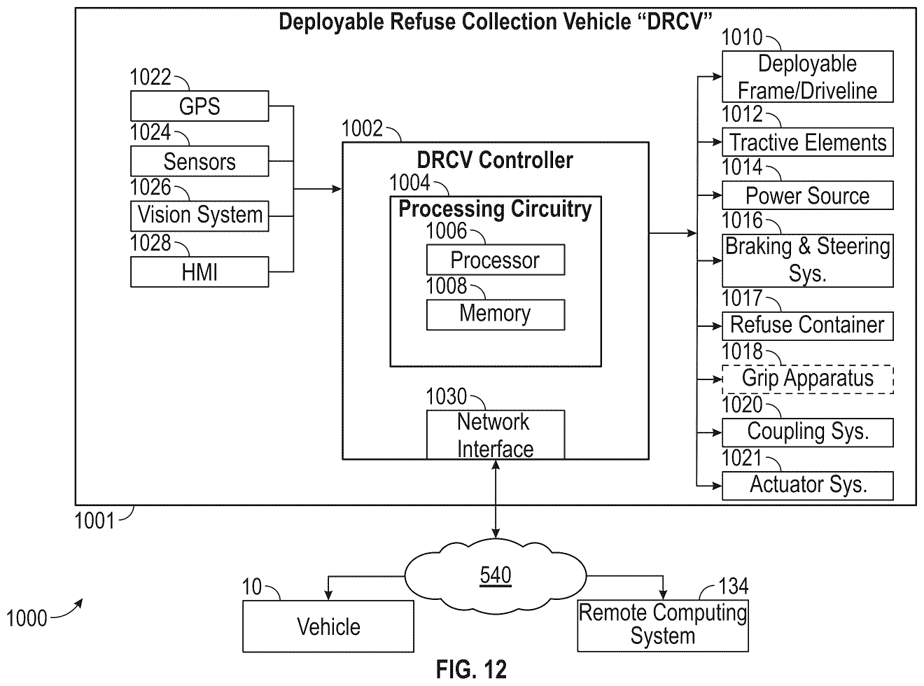

Referring to FIG. 12, a refuse collection system 1000 is shown that includes the refuse vehicle 10 and another DRCV 1001. The system 1000 may also include a remote computing system 134 through which commands, data, and the like are received to and from the refuse vehicle 10 and the DRCV 1001 via a network 540, as described above.

The DRCV 1001 may include similar features to the DRCV 501, such as GPS 1022, multiple sensors 1024, a vision system 1026 (e.g., an awareness system), and a HMI 1028. Likewise, the DRCV 1001 may also include controllable elements similar to those of the DRCV 501 such as a deployable frame/driveline 1010, tractive elements 1012, a power source 1014, a braking and steering system 1016, a grip apparatus 1018 (e.g., a robotic arm, a lift assembly, a forklift connector, etc.), and/or an actuator system 1021 (e.g., actuators to control the grip apparatus 1018, actuators to couple/decouple components of the DRCV 1001 to/from the refuse vehicle 10, actuators to fold/condense the frame 1010 for storage, etc.).

In addition to these features, the DRCV 1001 also includes a refuse container 1017 and a coupling system 1020. The refuse container 1017 may include a carry can, a hopper, or another suitable structure to receive refuse. In this way, the DRCV 1001 may travel separately from the refuse vehicle 10, collect refuse, and return to the refuse vehicle 10 so that the collected refuse may be stored within the refuse compartment 30 of the refuse vehicle 10. Beneficially, this may allow the DRCV 1001 to travel into areas that the refuse vehicle 10 cannot, thereby increasing the scope of refuse collection (e.g., into narrow alleyways, into neighborhoods that do not permit refuse vehicles 10, etc.). The coupling system 1020 allows the DRCV 1001 to couple to the refuse vehicle 10 (e.g., for storage) and to the refuse container 1017 (e.g., for deployment).

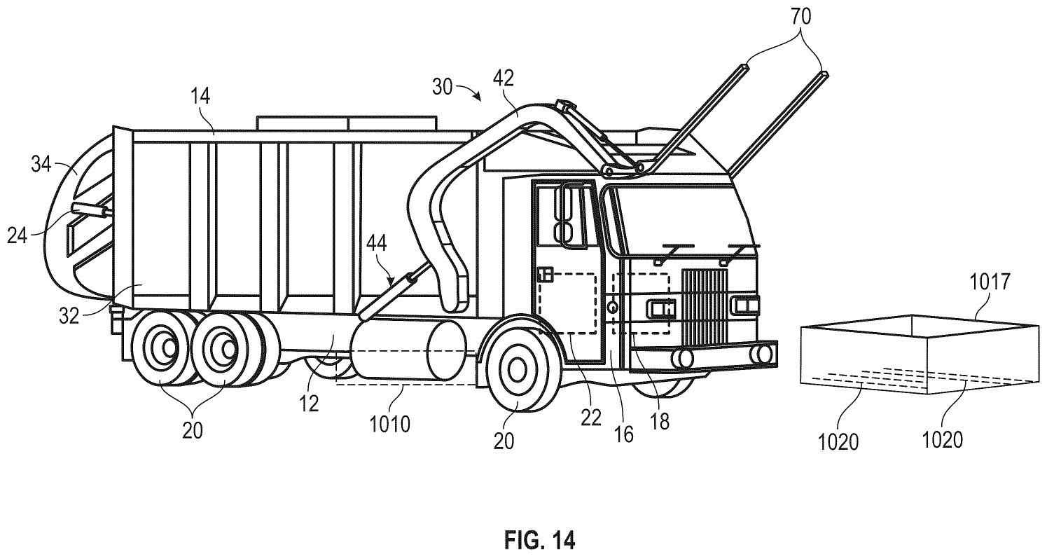

As shown in FIG. 14, when in a stored configuration, substantially all of the components of the DRCV 1001 may be coupled to and otherwise stored on the refuse vehicle 10. For example, the frame 1010, the tractive elements 1012 and the like may collapse, fold in, or otherwise reduce in size/profile such that they may be stored on the refuse vehicle 10. For example, the frame 1010 is shown stored underneath the refuse vehicle 10 in FIG. 14. The components of the DRCV 1001 may be stored at other locations on the vehicle 10. Additionally, in some embodiments, the refuse vehicle 10 may include one or more deployable vehicle docks 507 configured to receive and store the DRCV 1001. The refuse container 1017 of the DRCV 1001 may be configured to be attached to a component of the refuse vehicle 10 and operate/function in the refuse vehicle 10's normal operation. For example, the refuse container 1017 may be a carry can having pockets as part of the coupling system 1020, which may be received on forks 70 of a front-loading refuse vehicle 10. In this way, when the DRCV 1001 is not deployed, the refuse container 1017 may be used in the operation of the refuse vehicle 10. Similarly, to deploy the DRCV 1001, an operator may disconnect the refuse container 1017 from the refuse vehicle 10, deploy the DRCV 1001, couple the DRCV 1001 to the refuse container 1017, then operate the DRCV 1001 to perform a refuse collection operation.

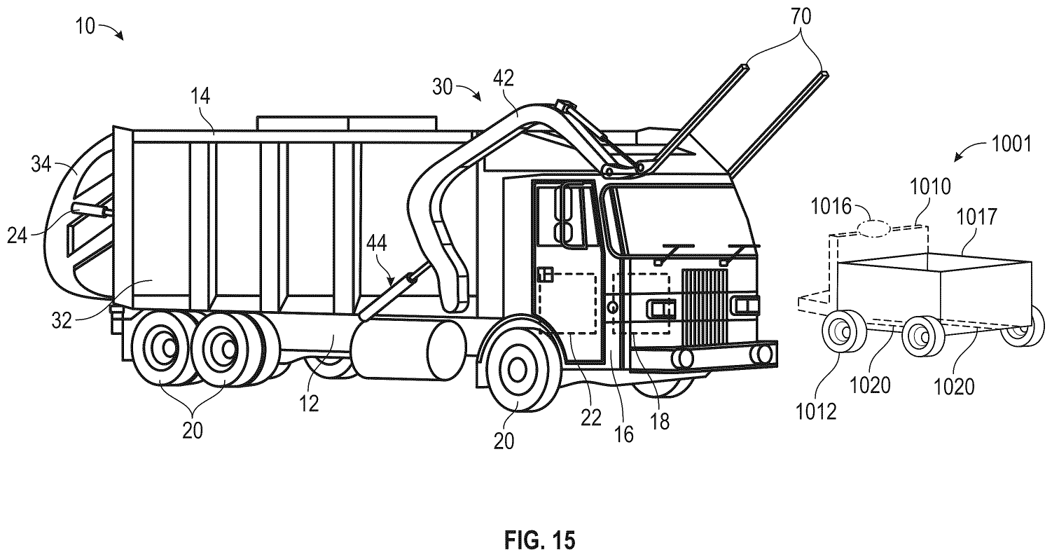

As shown in FIG. 15, the frame 1010, the tractive elements 1012, and other components of the DRCV 1001 have been deployed from the refuse vehicle 10 and have been coupled to the refuse container 1017. The frame 1010 may include an operator interface (e.g., a platform, a steering wheel, acceleration and brake pedals, grip apparatus control panel, etc.) on which the operator may be located and directly drive/navigate the DRCV 1001. In this way, the operator may park the refuse vehicle 10, deploy the DRCV 1001, begin a refuse collecting operation, and return to the refuse vehicle 10 when the refuse container 1017 is sufficiently filled. The operator may then recouple the refuse container 1017 to the refuse vehicle 10 and empty the refuse container 1017 into the refuse compartment 30. The operator may repeat this process. Beneficially, the DRCV 1001 may provide a smaller profile, less noise, and more energy efficiency when collecting refuse rather than driving the refuse vehicle 10 along the entire refuse collection route. Further, the smaller profile of the DRCV 1001 may allow the operator to collect refuse in areas that the refuse vehicle 10 cannot enter (e.g., narrow roadways, neighborhoods with noise restrictions on vehicles, etc.).

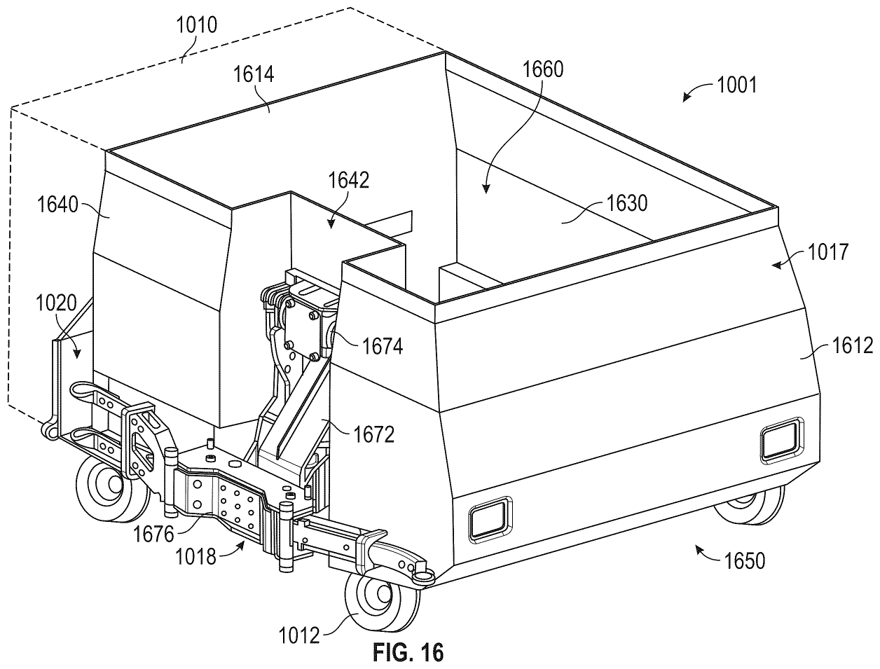

Referring now to FIG. 16, a detailed, perspective view of DRCV 1001 is shown, according to some embodiments. As shown, DRCV 1001 may include a container, shown as refuse container 1017, an articulating refuse collection arm, shown as grip apparatus 1018, and an interface of the coupling system 1020. The refuse container 1017 has a first wall, shown as front wall 1612, an opposing second wall, shown as rear wall 1614 (e.g., positioned between the cab 16 and the front wall 1612 when coupled to the refuse vehicle 10, positioned between the deployable frame 1010 and the front wall 1612 when coupled to the DRCV 1001, etc.), a first sidewall, shown as first sidewall 1630, an opposing second sidewall, shown as second sidewall 1640, and a bottom surface, shown as bottom 1650. The front wall 1612, the rear wall 1614, the first sidewall 1630, the second sidewall 1640, and the bottom 1650 cooperatively define an internal cavity, shown as container refuse compartment 1660. According to an exemplary embodiment, the container refuse compartment 1660 is configured to receive refuse from a refuse can 200 (e.g., a residential garbage can, a recycling bin, etc.).

As shown in FIG. 16, the second sidewall 1640 of the refuse container 1017 defines a cavity, shown as recess 1642. The grip apparatus 1018 is coupled to the refuse container 1017 and may be at least partially positioned within the recess 1642. In other embodiments, the grip apparatus 1018 is otherwise positioned (e.g., coupled to the first sidewall 1630, coupled to the front wall 1612, etc.). According to an exemplary embodiment, the grip apparatus 1018 includes an arm, shown as arm 1672; a grabber assembly, shown as grabber 1676, coupled to an end of the arm 1672; and an actuator, shown as actuator 1674. The actuator 1674 may be positioned to selectively reorient the arm 1672 such that the grabber 1676 is (a) extended laterally outward from and retracted laterally inward toward the refuse container 1017 to engage (e.g., pick up, etc.) a refuse container (e.g., a garbage can, a reclining bin, etc.) and/or (b) pivoted to facilitate emptying refuse into the container refuse compartment 1660.

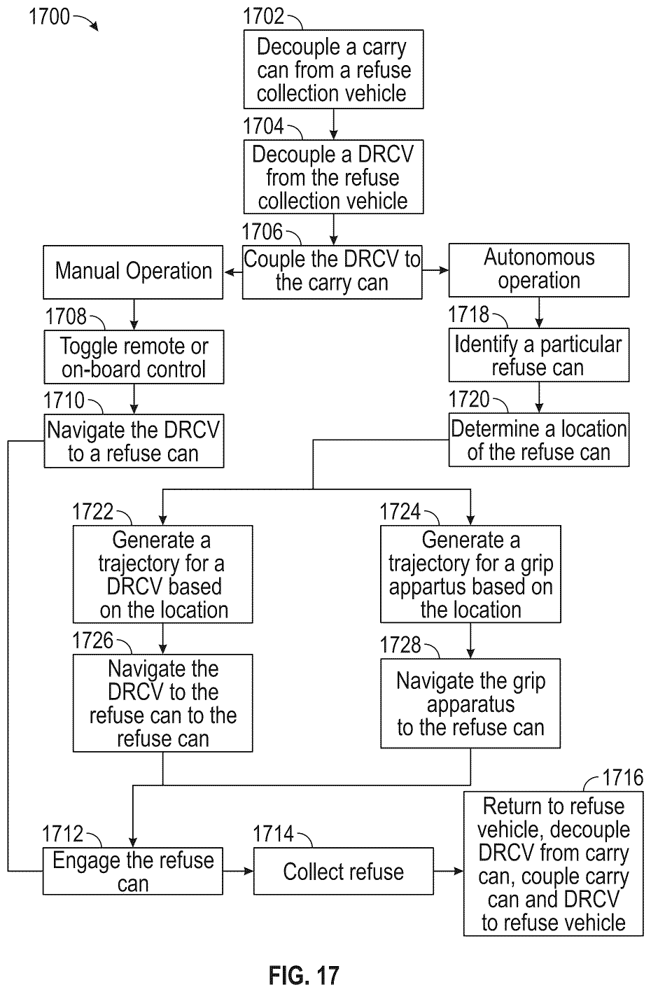

Turning to FIG. 17, a flow chart of a process of operating an embodiment of the DRCV 1001 is shown, according to an exemplary embodiment. Process 1700 may be implemented by an operator of the refuse vehicle 10 (e.g., via a user interface 503, by manually uncoupling and deploying the DRCV 1001, etc.) at the start of a refuse collection operation. Process 1700 may be wholly or partially implemented by the controller 102 of the refuse vehicle 10 and/or the DRCV controller 1002 described above.

At steps 1702-1706, a DRCV 1001 is deployed, for example, from a deployable vehicle dock 507. At step 1702, the operator may also uncouple or remove the refuse container 1017 from the refuse vehicle 10 (e.g., removing a carry can from a lift arms 42). In some embodiments, at step 1704 an operator may exit the cab 16 of the refuse vehicle 10 and unload, unmount, uncouple, or otherwise retrieve components of the DRCV 1001 from the deployable vehicle dock 507. The components may include the frame 1010, the tractive elements 1012, and the like. The operator may unplug a power connector or conduit from a charging port of the deployable vehicle dock 507. At step 1706, the operator may then connect the components of the DRCV 1001 together (e.g., couple the frame 1010 to the refuse container 1017). In this way, the DRCV 1001 may be configured as a self-propelled carry can, refuse container, etc. ready for deployment. In other embodiments, a signal (e.g., from the controller 102, from the user interface 503, etc.) may initiate a process to automatically uncouple or deploy the DRCV 1001 from the refuse vehicle 10. In some embodiments, the DRCV 1001 may be removed from the refuse vehicle 10, transitioned from the stored state to the deployed state, and begin operations. For example, the frame 1010 of the DRCV 1001 may be telescopically extended, assembled, unfolded, or otherwise configured to begin a refuse collection operation.

The DRCV 1001 may be operated in a manual state, an autonomous state, or a semiautonomous state such where the DRCV 1001 operates autonomously, but an operator may have supervisory control/oversight from the cab 16 or from a platform of the DRCV 1001.

In manual operation, the process proceeds to step 1708, toggling remote or on-board control. At this step, in some embodiments, an operator may navigate, drive, direct, or otherwise operate the DRCV 1001 by riding along or on the DRCV 1001 (e.g., on an operator platform) (step 1710). In this way, the operator may travel with the DRCV 1001 while carrying out the refuse collection operation. In other embodiments, the operator may remotely operate the DRCV 1001. For example, the operator may enter the cab 16, toggle a switch on the user interface 503 which designates that the controls of the refuse vehicle 10 will remotely control the DRCV 1001. The operator may receive visuals, data, displays, etc. from the sensors 1024 and/or vision system 1026 and, at step 1710, conduct the refuse collection operation remotely and navigate the DRCV 1001 to a refuse can 200 (e.g., by driving the DRCV 1001 and remotely collecting refuse via the grip apparatus 1018).

At step 1712, the refuse can 200 is engaged by the grip apparatus 1018. The refuse can 200 may be engaged by moving the grip apparatus 1018 in any suitable direction to engage and grip the refuse can 200. For example, the grip apparatus 1018 may move horizontally, vertically, and or orthogonally to the DRCV 1001 in order to engage the refuse can 200. Once the grip apparatus 1018 has secured the refuse can (e.g., by closing actuators), at step 1714, the grip apparatus 1018 and the DRCV 1001 may lift the refuse can 200 to empty the contents of the refuse can 200 into the refuse compartment 1660 of the refuse container 1017.

In autonomous or semi-autonomous operation, at step 1718, a particular refuse can 200 is identified. At step 1720, a location of the identified refuse can 200 is determined. At step 1722, a trajectory is generated for the DRCV 1001 based on the location of the refuse can 200. Simultaneously, at step 1724, a trajectory is generated for the grip apparatus 1018 of the DRCV 1001. At steps 1726 and 1728, the DRCV 1001 and grip apparatus 1018 navigate (e.g., move) to the refuse can 200. In autonomous and/or semi-autonomous operations, the DRCV 1001 and grip apparatus 1018 may be controlled or commanded (e.g., by DRCV controller 1002) to automatically navigate to the refuse can 200. For example, the DRCV 1001 may automatically move to the refuse can 200 and the grip apparatus 1018 may automatically move to engage the refuse can 200, without operator input. These steps may be performed in analogous manners as discussed above with respect to the process 800. Then, at step 1712, the refuse can is engaged by the grip apparatus 1018 and at step 1714, the grip apparatus 1018 and the DRCV 1001 may empty the refuse can into the refuse container 1017.

After the refuse container 1017 is full (e.g., a weight limit has been reached based on a scale of the sensors 1024, a volume/capacity has been reached based on visuals from the vision system 1026, an operator manually determines that the refuse container 1017 is at capacity, etc.), at step 1716, the DRCV 1001 may return to the refuse vehicle 10. The refuse container 1017 may be decoupled from the DRCV 1001 and coupled to the refuse vehicle 10. The refuse vehicle 10 may then empty the refuse container 1017. The DRCV 1001 may recouple to the refuse container 1017 and continue the refuse collection operation, or both the DRCV 1001 and the refuse container 1017 may be coupled to the refuse vehicle 10 to complete the refuse collection operation. In some embodiments, the DRCV 1001 does not need to be decoupled from the refuse container 1017 for the refuse container 1017 to be emptied by the refuse vehicle 10.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A refuse collection system comprising:
a deployable refuse collection vehicle configured to deploy from a refuse vehicle, the deployable refuse collection vehicle including:
a chassis;
a drive system coupled to the chassis;
one or more sensors configured to acquire data to facilitate detecting a refuse can; and
a grip apparatus configured to engage the refuse can; and
a control system configured to:
detect the refuse can based on the data;
control the drive system to navigate the deployable refuse collection vehicle to the refuse can; and
control the grip apparatus to engage with the refuse can.

2. The refuse collection system of claim 1, further comprising the refuse vehicle having a deployable vehicle dock configured to receive and store the deployable refuse collection vehicle.

3. The refuse collection system of claim 2, wherein the deployable refuse collection vehicle includes a battery, and wherein the deployable vehicle dock is configured to facilitate charging the battery.

4. The refuse collection system of claim 1, wherein the control system is configured to:
determine a staging location for the refuse can; and
control the drive system to move the refuse can to the staging location.

5. The refuse collection system of claim 1, wherein the deployable refuse collection vehicle includes a refuse container coupled to the chassis.

6. The refuse collection system of claim 5, wherein the grip apparatus is coupled to the refuse container.

7. The refuse collection system of claim 6, wherein the refuse container is a carry can that is detachable from the chassis and attachable to a lift assembly of the refuse vehicle.

8. The refuse collection system of claim 5, wherein the grip apparatus is configured to lift the refuse can and empty contents therein into the refuse container.

9. The refuse collection system of claim 1, wherein the one or more sensors include at least one of a camera, a LIDAR sensor, or a radar sensor.

10. The refuse collection system of claim 1, wherein the deployable refuse collection vehicle is remotely operable.

11. The refuse collection system of claim 1, wherein the deployable refuse collection vehicle is autonomous or semi-autonomous.

12. The refuse collection system of claim 1, wherein the control system includes at least one of (a) a first processing circuit located on the deployable refuse collection vehicle or (b) a second processing circuit remote from the deployable refuse collection vehicle.

13. A refuse collection system comprising:
a refuse collection robot including:
a drive system;
a sensor configured to acquire data to facilitate detecting a refuse can; and
a grabber configured to engage the refuse can; and
a control system configured to:
detect the refuse can based on the data;
control the drive system to navigate the refuse collection robot to the refuse can; and
control the grabber to engage with the refuse can.

14. The refuse collection system of claim 13, further comprising a refuse vehicle having a deployable vehicle dock configured to receive and store the refuse collection robot.

15. The refuse collection system of claim 14, wherein the refuse collection robot includes a battery, and wherein the deployable vehicle dock is configured to facilitate charging the battery.

16. The refuse collection system of claim 13, wherein the control system is configured to:
determine a staging location for the refuse can; and
control the drive system to move the refuse can to the staging location.

17. The refuse collection system of claim 13, wherein the refuse collection robot includes a refuse container.

18. The refuse collection system of claim 17, wherein the grabber is coupled to the refuse container, and wherein the grabber is configured to lift the refuse can and empty contents therein into the refuse container.

19. The refuse collection system of claim 17, wherein the refuse container is a carry can that is detachable from refuse collection robot and attachable to a lift assembly of the refuse vehicle.

20. A refuse collection system comprising:
a front-loading refuse collection vehicle having a lift assembly and a dock;
a carry can detachably coupled to the lift assembly, the carry can including a grabber mechanism; and
a deployable robot selectively coupled to the dock, the deployable robot having a battery chargeable at the dock;
wherein the deployable robot is configured to engage with the carry can when the carry can is detached from the lift assembly such that the carry can is movable by the deployable robot.
